(19) United States
(12) Patent Application Publication
(10) Pub. No.: US 2010/0307356 A1
(43) Pub. Date: Dec. 9, 2010

(54) BRIDGED SLEEVE/CYLINDER AND METHOD OF MAKING SAME FOR WEB OFFSET PRINTING MACHINES

(76) Inventor: Felice Rossini, Milano (IT)

Correspondence Address: DORITY & MANNING, P.A., POST OFFICE BOX 1449, GREENVILLE, SC, 29602-1449, US

(21) Appl. No.: 12/864,700

(22) PCT Filed: Feb. 3, 2009
(86) PCT No.: PCT/IB2009/050443

§ 371 Date: Jul. 27, 2010

Related U.S. Application Data
(63) Continuation-in-part of application No. 12/135,405, filed on Jun. 9, 2008.
(60) Provisional application No. 61/026,021, filed on Feb. 4, 2008.

(51) Int. Cl. B41F 13/10

(52) U.S. Cl. 101/375

(57) ABSTRACT

A method of making a bridged blanket sleeve or bridged blanket mandrel for an offset printing machine or rotary printing machine includes forming an intermediate bridge section between an outermost single blanket layer and an innermost core layer or the outer surface of the mandrel. The intermediate section of the sleeve or mandrel so made can include one or more intermediate bridge layers. A bridged blanket sleeve or a bridged blanket mandrel for an offset printing machine or rotary printing machine includes an intermediate bridge section between an outermost single blanket layer and an innermost core layer or the outer surface of the mandrel. The intermediate section of the sleeve or mandrel can include one or more intermediate bridge layers.

### CROSS-REFERENCE TO RELATED APPLICATIONS

The present application claims priority to currently pending U.S. patent application Ser. No. 61-026,021 filed Feb. 4, 2008, and U.S. patent application Ser. No. 12-135,405, filed Jun. 9, 2008, which are hereby incorporated herein by this reference for all purposes.

### STATEMENT REGARDING FEDERALLY SPONSORED RESEARCH OR DEVELOPMENT

N/A

### BACKGROUND OF THE INVENTION

The present invention relates to a blanket sleeve or blanket cylinder for an indirect or offset printing machine and as well as to methods for making such sleeves and cylinders.

Offset printing machines or lithographic rotary printing machines with indirect printing are known, and examples are schematically represented in FIG. 1 of U.S. Pat. Nos. 5,440,981 and 5,429,048, which patents are hereby incorporated herein in their entirety for all purposes by this reference. It is known that an offset machine or a lithographic rotary machine with indirect printing mainly comprises three rigid cylinders, usually made of steel. A first cylinder carries lithographic plates that, after being disposed into contact with inking rollers and wetting rollers, carry ink on some portions of the plates and an absence of ink on other portions of the plates and thus carry inked data thereon. A second, subsidiary cylinder (or blanket cylinder) receives the inked data to be printed (i.e., “the impression”) from the first cylinder. These data are transferred to a substrate or web of paper or other material (for example plastic), which is interposed between the blanket cylinder and a third cylinder, which commonly is known as the backing cylinder if only one side of the substrate is to be printed. If both sides of the substrate are to be printed, then two blanket cylinders are employed. After transforming the inked data to the substrate, the surface of each blanket cylinder passes through a bath of solvents that wash the residual ink from the surface of the blanket cylinder. Over time, the ink, which can be acetate-based or alcohol-based, and the solvents tend to degrade the materials forming the blanket cylinder.

The blanket cylinder acquired this name because the rigid blanket cylinder of the printing machine is usually covered with a natural rubber blanket, which can have either a “compressible” structure, i.e., with a compressible layer, or a “conventional” structure, i.e., without a compressible layer. Various methods (and corresponding products) for producing the blanket cylinder are known. One of these methods uses a blanket in the form of a flat sheet composed of natural rubber with a yieldable (compressible) structure. The cylinder's surface has an axial slot disposed parallel to the longitudinal axis. The rubber is wrapped about the blanket cylinder with the ends of the sheet of rubber inserted into the slot and fixed to the cylinder by inserting a bar into the axial slot to retain the ends of the rubber therein.

Alternatively, a cylindrical blanket sleeve can be carried by a rotary support or mandrel, which together with the blanket sleeve function as the blanket cylinder. Such a blanket sleeve typically includes an inner cylindrical portion or core that is formed as a hollow cylindrical body or sleeve. The core is typically formed of a thin-walled nickel tube that has a radial thickness in the range of seven thousandths of an inch thick to ten thousandths of an inch. The core is configured to be selectively drawn over the mandrel and locked to the mandrel. Thus, the blanket sleeve can be mounted on and dismounted from the mandrel, as by pressurized air for example, and therefore is independent from the rotary mandrel of the offset press. The blanket sleeve includes a compressible layer positioned on the inner cylindrical portion (core), a substantially incompressible reinforcement layer positioned on the compressible layer, and finally a printing layer that receives the inked data.

The compressible layer comprises a first continuous tubular body (without joints) of elastomeric material (nitrile rubber, e.g., acrylo-nitrile butadiene) presenting internally a plurality of cavities that determine the “compressibility” of the layer. To produce this compressible layer on the inner cylinder (core) first requires placing the nitrile rubber material into solution to form a liquid. This is accomplished by adding solvents to the solid nitrile rubber to provide the nitrile rubber in liquid solution. Then microspheres (that ultimately will produce the desired cavities in the compressible layer) are mixed into that nitrile rubber solution. Then, in a very time consuming process that requires considerable operator skill, the nitrile rubber solution with the microspheres is applied to the surface of the inner cylinder (core) by a knife coating technology or ring coating technology for example to build up a precursor layer of about one millimeter in radial thickness. However, because nitrile rubber does not adhere well to nickel surfaces, when the core is formed of nickel, an adhesive preparation must be provided. For example, a liquid adhesive paint is typically first applied to the surface of the nickel core, and the nitrile rubber solution is applied to the exposed surface of the coating of liquid adhesive paint rather than to the bare nickel surface.

The use of a knife coating technology to produce this precursor layer requires an operator to mount the core onto a rotating mandrel. As the mandrel rotates, the operator must apply the liquid rubber solution with the microspheres to the surface of the rotating core. At the same time, a knife blade rises automatically to even out the surface being created while heated air is applied to remove the solvent from the solution as the core is rotating. The amount of solution being applied by the operator will vary depending on the consistency of the solution. If the solution is running it will not form the solid layer around the core. The consistency of the solution depends on the atmospheric ambient conditions of temperature, humidity and barometric pressure. These conditions also affect whether the solvent is removed completely during each revolution of the core on the mandrel. The solvent, which is volatile, must be completely removed prior to the next step, which is subjecting the precursor layer to heat that is sufficient (100 to 130 degrees centigrade) to cure the rubber. The generation of the precursor layer using the knife coating technology takes on the order of two to three hours for a typical sleeve or cylinder.

Once this preliminary thickness of the precursor layer has been attained, the nitrile rubber forming the precursor layer must be cured by the application of heat and pressure in another time-consuming process that requires operator manipulation of the cylinder. First, a tape that shrinks when subjected to curing temperatures (noted above) is wound around the precursor layer. The taped sleeve may be placed into an oven and maintained at curing temperatures (noted above) for two to three days. As the tape shrinks, the necessary pressure is applied to the precursor layer in order to effect curing of the nitrile rubber. Once the curing step is done, the cylinder must be manipulated to another station where the surface of the precursor layer can be ground down to the desired thickness (typically three tenths to seven tenths of a millimeter) of the compressible layer forming a tubular body.

Reinforcement structures such as threads or meshes (of cotton or other material) can be built on top of the compressible layer. The reinforcement layer can be defined by an elastomeric matrix containing threads, preferably of cotton. The threads can be continuous or discontinuous. These reinforcement structures can be applied spirally or linearly on the compressible layer. The function of this reinforcement layer is to form a support structure with physical and mechanical characteristics that are far superior to those of the elastomeric nitrile rubber matrix that forms the compressible layer and the outer printing layer (now to be described).

Finally, the surface printing layer is formed of elastomeric material (nitrile rubber) on top of the tubular body with the reinforced structure. The surface printing layer can be formed like the compressible layer, except without the use of microspheres and the voids created thereby. Alternatively, the surface printing layer can be formed by another technology such as by extrusion of a natural rubber sleeve onto and around the reinforcing layer. The final surface of the outer printing layer is continuous and without joints. All of the layers of the known sleeve are all bonded together to form a single body. However, the required operator involvement and manipulation steps in the production process required to fabricate the known blanket sleeve prevent significant automation of this fabrication process. The low level of automation adversely affects the consistency of the sleeve that can be produced.

The consistency of the compressible layer is important for printing quality, and end users of the blanket sleeves are specifying acceptable ranges for compressibility. Indeed, the rampant inconsistency of the blanket sleeves has led many end users of the sleeves to test newly acquired sleeves and grade them A, B or C according to the degree of compressibility and assign them accordingly for various types of printing jobs. Moreover, the compressibility must stay within the specified range over time. However, the consistency of the compressible layer obtainable in the known rubber blanket sleeves is limited by the high degree of operator involvement and judgment during the fabrication process as well as by the unpredictable ambient conditions under which different sleeves are made for the same end-user. Moreover, residual solvent in the compressible layer will continue to create voids in the compressible layer and thus changes the compressibility of the overall sleeve over time. Residual solvent is a consequence of the fabrication process of the known rubber blanket sleeves. Thus, while a known rubber blanket sleeve may be delivered to the end-user with an acceptable compressibility, the compressibility of that sleeve may change enough over time to become outside the acceptable range.

Additionally, the aforesaid known blanket cylinder presents an outer layer of natural rubber or elastomeric material with inferior physical and mechanical characteristics, equivalent to those of rubber. The outer layer has poor mechanical strength, at least partly because of these characteristics of natural rubber. Consequently, the outer layer undergoes considerable wear during use. This wear is caused by the action on this outer layer of the blanket sleeve by the metal plate of the plate cylinder or by the edges of the substrate being printed, or by poor resistance to the wash solvents used in the printing process. A fold or other thickness variation in the substrate can irreversibly damage the surface of the outer layer and render the entire sleeve or cylinder useless.

Moreover, the recurring pressure applied to the printing surface during repeated printing on the press eventually overcomes the outer layer's reboundability, i.e., its ability to resist permanent compression. Once the original thickness of this outer printing layer is diminished, the blanket sleeve becomes incapable of transferring the inked data to the substrate with the desired resolution of the printed image. This is particularly a problem in presses that print on both sides of the substrate and thus have a blanket cylinder on each side of the substrate, thus potentially doubling the problem as a bad image on one side of the substrate renders the entire substrate useless.

Furthermore, when the sleeve has a thin nickel core, the sleeve can become irreversibly damaged because the thin nickel core tends to kink during mounting and dismounting of the sleeve onto the rotary mandrel of the offset printing machine. These factors combine to curtail the “useful life” or duration of a blanket sleeve of the aforesaid known type. This curtailment presents obvious drawbacks from an economical viewpoint, especially in the cost of employing an offset printing machine that requires a plurality of blanket cylinders.

Commonly owned U.S. Pat. No. 6,688,226, which hereby is incorporated herein in its entirety for all purposes by this reference, disclosed blanket sleeve technology that overcame these problems with a three layer blanket sleeve that employed polyurethane material for the compressible layer instead of the nitrile rubber found in conventional blanket sleeves. This blanket sleeve also used polyurethane to form the incompressible blanket layer instead of the nitrile rubber found in conventional blanket sleeves. In some embodiments of this blanket sleeve, a fourth layer in the form of a reinforcing layer was interposed between the compressible layer and the incompressible blanket layer.

To make this improved blanket sleeve included starting with a cylindrical body to define the inner cylindrical portion of the blanket sleeve. The cylindrical body was composed of nickel, or a metal wire mesh or resin embedded with fiber such as fiberglass, carbon fiber, or aramid fiber.

Then a first pasty polyurethane material was deposited on the outer surface of the inner cylindrical portion. The first pasty polyurethane material is preferably elastomeric such as a polyether polyurethane or polyester polyurethane. The first pasty polyurethane material can be obtained by mixing a polyol and microspheres having a shell of a phenolic type of thermosetting resin surrounding a gas like isobutane or by mixing a polyol and swelling agents that release gas when heated or by mixing a polyol and water-soluble salts such as sodium chloride, magnesium chloride or magnesium sulphate. Ribbon technology was desirably used for depositing the first pasty polyurethane material on the outer surface of the inner cylindrical portion.

Then the first pasty polyurethane material was caused to solidify on the outer surface of the inner cylindrical portion to define the compressible layer of the sleeve. Causing the first pasty polyurethane material to solidify on the outer surface of the inner cylindrical portion was desirably accomplished by cross-linking the first polyurethane material at ambient pressure. This cross-linking could be allowed to proceed for about five hours if carried out at ambient temperature or could be accelerated by the addition of heat and/or cross-linking agents. Then the compressible layer was ground to the desired thickness and uniform surface.

Then at least one blanket layer was formed on the compressible layer, and the blanket layer so formed included polyurethane material carried by the cylindrical body and defining a printing surface for receiving the inked data to be transferred to the substrate. The incompressible blanket layer was formed of a second pasty polyurethane material that is preferably elastomeric such as a polyether polyurethane or polyester polyurethane. The blanket layer was formed by ribbon technology or by extrusion technology for example. If formed by ribbon technology, cross-linking could occur at ambient pressure. Cross-linking also could occur at ambient temperature or could be accelerated by the addition of heat and/or cross-linking agents. The incompressible blanket layer was ground to the desired thickness and uniform surface.

Alternatively, if a blanket sleeve with a fourth layer was desired, then the method could include forming the incompressible blanket layer on a reinforcing layer that is formed around the compressible layer. The reinforcing layer could be formed in any conventional way.

Offset printing machines from the same manufacturer have spindles with the same diameter. Moreover, the radial thickness of a blanket sleeve or cylinder is limited by the fact that performance of the sleeve in the printing machine suffers if the radial thickness varies by a fraction of an inch above or below the ideal thickness. Accordingly, the diameter of the machine's spindle and the radial thickness tolerance of the blanket layer constrain the repeat size that a given blanket sleeve or cylinder can accommodate.

### OBJECTS AND SUMMARY OF THE INVENTION

It is a principal object of the present invention to provide an improved blanket sleeve or cylinder that has adequate circumference to accommodate printing jobs that require more extensive repeats or circumferences. Another principal object of the present invention is therefore to provide a bridged blanket mandrel and/or bridged blanket sleeve having one or more bridge layers interposed between the innermost core layer or mandrel surface and the outermost blanket layer to be able to be accommodate printing jobs that require more extensive repeats. The bridged blanket cylinder and/or bridged blanket sleeve nonetheless should have at least comparable, if not superior, physical and mechanical characteristics than known cylinders and/or sleeves such as to offer high wear resistance, better reboundability, and greater resistance to creases in the surface and hence prolong the useful life of the product. The bridged blanket sleeve should be able to be removably coupled to the rotary member or support (mandrel) of the offset printing machine to form a portion of the blanket cylinder.

Still another principal object is to provide both a bridged blanket sleeve and a bridged blanket mandrel, each having a single polyurethane blanket layer that is so consistent in regards to compressibility and surface tension that the bridged blanket sleeve or bridged blanket mandrel does not need to be individually categorized like current blanket sleeves and mandrels.

A further object is to provide both a bridged blanket sleeve and a bridged blanket mandrel of the stated type having a lower cost than known blanket sleeves for known blanket cylinders.

A still further object of the invention is to provide a method whereby both a bridged blanket sleeve and a bridged blanket mandrel of the stated type can be produced in a shorter time than conventional blanket sleeves and mandrels.

A yet further object of the invention is to provide a method whereby a consistent bridged blanket sleeve and bridged blanket mandrel of the stated type can be produced regardless of ambient conditions and personnel available during production.

Another object of the invention is to provide a method whereby both a bridged blanket sleeve and a bridged blanket mandrel of the stated type can be produced by procedures that are more automated than the procedures for making conventional blanket sleeves.

Additional objects and advantages of the invention will be set forth in part in the description that follows, and in part will be obvious from the description, or may be learned by practice of the invention. The objects and advantages of the invention may be realized and attained by means of the instrumentalities and combinations particularly pointed out in the appended claims.

To achieve the objects and in accordance with the purpose of the invention, as embodied and broadly described herein, the bridged blanket sleeve includes an intermediate bridge section that is disposed between an outermost single blanket layer and an innermost core layer. Similarly, an embodiment of the bridged blanket mandrel includes an intermediate bridge section that is disposed between an outermost single blanket layer and the surface of the mandrel. In each case, sleeve and mandrel, the intermediate bridge section desirably includes one or more bridge layers.

In a sleeve or mandrel in which the combined radial thickness of the single blanket layer and the intermediate bridge section measures about 5 mm or less, the intermediate bridge section desirably can include a single bridge layer that is a blanket support layer and that has a Shore D hardness of about 80, which desirably can be provided by a single bridge layer formed of polyurethane.

In a sleeve or mandrel in which the combined radial thickness of the single blanket layer and the intermediate bridge section measures more than about 5 mm, the intermediate bridge section desirably can include in addition to a first bridge layer that is a blanket support layer having a Shore D hardness of about 80, a second bridge layer that is a central spacer layer having a Shore D hardness of about 30 and a third bridge layer that is a base bridge layer having a Shore A hardness of about 40. Each of the blanket support layer, the central spacer layer and the base bridge layer desirably is formed of polyurethane.

In an alternative embodiment of a sleeve or mandrel in which the combined radial thickness of the single blanket layer and the intermediate bridge section measures more than about 5 mm, the intermediate bridge section desirably can include in addition to a first bridge layer that is a blanket support layer that is formed of a metal layer, a second bridge layer that is a central spacer layer having a Shore D hardness of about 30 and a third bridge layer that is a base bridge layer having a Shore A hardness of about 40. In this alternative embodiment, the metal layer desirably is formed of aluminum, and each of the central spacer layer and the base bridge layer desirably is formed of polyurethane.

In each embodiment of a sleeve or mandrel in which the combined radial thickness of the single blanket layer and the intermediate bridge section measures more than about 5 mm, the intermediate bridge section desirably can include one or more joining layers that serve as substrates on which other layers can be formed and/or can be disposed between the layers of different hardness ratings. Each of these joining layers desirably is formed of a composite material having a Shore D hardness of about 90 and containing at least one kind of fibers selected from the group of kinds of fibers consisting of carbon fibers, glass fibers, and aramid fibers. The radial thickness of each of these joining layers desirably is between about 0.1 mm and about 2.0 mm depending on the material used for its construction.

The intermediate bridge section is formed on either the surface of the mandrel or on an innermost cylindrical core layer portion, which desirably is formed of a composite material having a Shore D hardness of about 90 and containing at least one kind of fibers selected from the group of kinds of fibers consisting of carbon fibers, glass fibers, and aramid fibers. The radial thickness of innermost cylindrical core layer portion desirably is between about 0.1 mm and about 2.0 mm depending on the material used for its construction. Alternatively, the innermost cylindrical core layer portion can be formed of nickel and desirably should have a radial thickness in a range of about 0.1 mm to about 0.5 mm. Each bridge layer of the intermediate bridge section is built up successively on the underlying layer in the conventional fashion.

The single blanket layer structure overlays and is integrally connected to the outermost cylindrical surface of the intermediate bridge section and consists essentially of polyurethane material and microspheres, which are uniformly dispersed throughout the single blanket layer. The microspheres constitute no less than about 0.6 percent by weight and no more than about 4.4 percent by weight of the single blanket layer. The single blanket layer desirably is formed of a precursor that is deposited by ribbon technology onto the outer cylindrical surface of the intermediate bridge section after the intermediate bridge section has been formed on either the surface of the mandrel or on an innermost cylindrical core layer portion. The precursor from which the single blanket layer desirably is formed consists essentially of three main components, namely, polyol, curing agent and microspheres. For every about 100 grams of polyol in the precursor material, there are from about 30 grams to about 60 grams of the curing agent and from about one gram to about six grams of the microspheres. Thus, in the precursor material, the microspheres constitute between about one percent (1%) by weight of the polyol component and about six percent (6%) by weight of the polyol component. The curing agent for the polyol is provided such that the weight ratio of the polyol to the curing agent is in the range of about 100:30 to about 100:60. In one presently preferred example, for every 100 grams of polyol in the precursor material, the microspheres constitute 1.8 grams in the precursor material, and the curing agent constitutes 50 grams in the precursor material.

As embodied and broadly described herein, the improved method of making the improved bridged blanket sleeve includes providing a cylindrical body to define the intermediate bridge section of the bridged blanket sleeve. The cylindrical body that defines the intermediate bridge section of the bridged blanket sleeve desirably has a blanket support layer composed of either a metal layer or a polyurethane layer having a Shore D hardness of about 80 as described herein.

The method desirably includes forming the single blanket layer on the blanket support layer, which defines the outermost surface of the intermediate bridge section, by depositing on the outer surface of the blanket support layer a runny polyurethane precursor material containing proportionately by weight: 100 parts polyol, about 30 parts to about 60 parts isocyanate, about 1 part to about 6 parts non-expanding microspheres and about 3 parts thixotropic agent. The density of the runny polyurethane precursor material is desirably in a range of between about 0.6 kg/dm³ and about 0.8 kg/dm³ and desirably is about 0.7 kg/dm³. The polyol is preferably elastomeric such as a polyether polyurethane or a polyester polyurethane.

However, desirably, for each 100 grams of polyol in the precursor material there are between about 1 gram of microspheres to about 3 grams of microspheres. Desirably, for each 100 grams of polyol in the precursor material there are between about 1 gram of microspheres to about 2 grams of microspheres. Desirably, in one example, for each 100 grams of polyol in the precursor material there are 1.5 grams of microspheres. Desirably, in a presently preferred example, for each 100 grams of polyol in the precursor material, there are 1.8 grams of microspheres in the precursor material.

Additionally, the weight proportion of isocyanate can be varied from 50 parts for every 100 parts of polyol to proportionately vary the Shore A hardness of the finished single blanket layer of the bridged blanket sleeve such that each part above or below 50 parts will translate roughly into 3 or 4 points above or below, respectively, in the Shore A hardness of the finished single blanket layer of the bridged blanket sleeve.

Ribbon flow technology is desirably used for depositing the runny polyurethane precursor material on the outer surface of the blanket support layer. Desirably, the intermediate bridge section is mounted on a cylindrical mandrel of a ribbon flow technology dispensing system. The polyol containing the desired percent by weight of microspheres can be provided to the mixing head of the ribbon flow technology dispensing system and can be combined with a curing agent (isocyanate) in the mixing head before being dispensed from a nozzle immediately downstream of the mixing head and onto the outer surface of the blanket support layer in ribbons that helically wind around the blanket support layer as the mandrel rotates. As the mandrel rotates, the nozzle can be moved axially to make successive passes back and forth over the length of the precursor sleeve. With each pass down the length of the blanket support layer, the nozzle deposits a continuous ribbon of the runny polyurethane precursor material around the precursor sleeve until a desired radial thickness of the polyurethane precursor material is attained. Typically, only a single pass down the length of the blanket support layer will suffice, and this single pass can be completed in about ten minutes for a typical bridged blanket sleeve. Then the polyurethane precursor material is allowed to cure in order to solidify and thereby form a single solid polyurethane blanket layer on the blanket support layer.

Causing the runny polyurethane precursor material to solidify to form a single polyurethane blanket layer on the outer surface of the blanket support layer is desirably accomplished by cross-linking the runny polyurethane precursor material at ambient pressure and temperature. This cross-linking can be allowed to proceed for about twenty-four hours to about forty-eight hours if carried out at ambient temperature and pressure or can be accelerated by the addition of heat and/or cross-linking agents. The density of the cured single polyurethane blanket layer is desirably in a range of between about 0.6 kg/dm³ and about 0.8 kg/dm³ and desirably is about 0.7 kg/dm³.

After the single polyurethane blanket layer has cured into a solid, integrally formed blanket layer, then the exterior surface of the single polyurethane blanket layer is ground to a uniform parallel surface on the exterior surface of a solid polyurethane blanket layer of the desired radial thickness above the inner cylindrical core. The parallel exterior cylindrical surface of the single blanket layer can be finished by being polished, which can be accomplished by machine or manually.

The result is a bridged blanket sleeve that employs only one blanket layer that desirably is composed of polyurethane containing evenly dispersed microspheres, which taken together occupy from about 0.6 percent by weight to about 4.4 percent by weight of the single, solid polyurethane blanket layer, and that functions to provide adequate compressibility as found in conventional blanket sleeves and adequate incompressibility as required in conventional blanket sleeves and without any reinforcing layer. The single, solid polyurethane blanket layer extends over the blanket support layer and has a density that desirably is between about 0.6 kg/dm³ and about 0.8 kg/dm³ and desirably is about 0.7 kg/dm³.

The exterior surface (printing surface) of the single, solid polyurethane blanket layer of the bridged blanket sleeve desirably has a hardness of between about 50° Shore A and about 75° Shore A, and desirably between about 55° Shore A and about 65° Shore A, and desirably between about 58° Shore A and about 62° Shore A, and desirably is about 60° Shore A.

The finished outer diameter of the single, solid polyurethane blanket layer of the bridged blanket sleeve desirably has a tolerance of plus 0.02 mm and minus 0.01 mm. The total indicated runout (TIR, indicative of the degree to which the surface is out of round) of the finished outer surface of the single, solid polyurethane blanket layer of the bridged blanket sleeve desirably is a maximum of 0.02 mm.

Though the finished exterior surface of the single, solid polyurethane blanket layer of the finished sleeve has tiny pores where the microspheres have released from the surface, as long as the weight of microspheres per 100 grams of polyol in the precursor material is kept within the critical range of not less than about one gram and not greater than about six grams, then the surface tension of the exterior surface of the finished bridged blanket sleeve should be conducive to releasing the ink to the substrate when the sleeve is in use on the printing machine.

Similarly, a bridged blanket mandrel can be provided that employs only one blanket layer that is identical to the single, solid polyurethane blanket layer described above for the bridged blanket sleeve. The one blanket layer can be formed on a blanket support layer such as described herein. However, the mandrel can take the place of the inner cylindrical body of the bridged blanket sleeve described herein and alternatively can be provided by a steel cylinder or an aluminum tube or an aluminum clad sleeve.

An offset machine desirably can be provided with bridged blanket mandrels covered with the single polyurethane blanket layer described above or can be provided with mandrels on which can be mounted bridged blanket sleeves covered with the single polyurethane blanket layer described above.

The accompanying drawings, which are incorporated in and constitute a part of this specification, illustrate at least one presently preferred embodiment of the invention as well as some alternative embodiments. These drawings, together with the description, serve to explain the principles of the invention but by no means are intended to be exhaustive of all of the possible manifestations of the invention.

### BRIEF DESCRIPTION OF THE DRAWINGS

FIG. 1 is an elevated perspective view of an example of an embodiment of a bridged blanket sleeve of the present invention that is shown mounted to the blanket mandrel of an offset printing machine or a lithographic rotary printing machine.

FIG. 2 schematically shows a block diagram of a presently preferred embodiment of a method for obtaining a bridged blanket sleeve or bridged blanket mandrel in accordance with the invention.

FIG. 3 schematically represents a perspective view of an alternative embodiment of the invention showing a bridged blanket mandrel with an intermediate blanket section having an innermost surface permanently attached to the outer cylindrical surface of a steel mandrel and an outermost cylindrical surface permanently attached to the innermost surface of a single blanket layer.

FIG. 4A schematically illustrates an elevated perspective view of a partial section of one embodiment of a bridged blanket sleeve taken from the region designated 4-4 in FIG. 1 in accordance with the present invention.

FIG. 4B schematically illustrates an elevated perspective view of a partial section of another embodiment of a bridged blanket sleeve or mandrel in accordance with the present invention.

FIG. 4C schematically illustrates an elevated perspective view of a partial section of still another embodiment of a bridged blanket sleeve or mandrel in accordance with the present invention.

FIG. 5 schematically represents an offset machine provided with at least one bridged blanket mandrel and a bridged blanket sleeve that is mounted integrally on a blanket cylinder.

### DETAILED DESCRIPTION OF THE PREFERRED EMBODIMENTS

Reference now will be made in detail to the presently preferred embodiments of the invention, one or more examples of which are illustrated in the accompanying drawings. Each example is provided by way of explanation of the invention, which is not restricted to the specifics of the examples. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention cover such modifications and variations as come within the scope of the appended claims and their equivalents. The same numerals are assigned to the same components throughout the drawings and description.

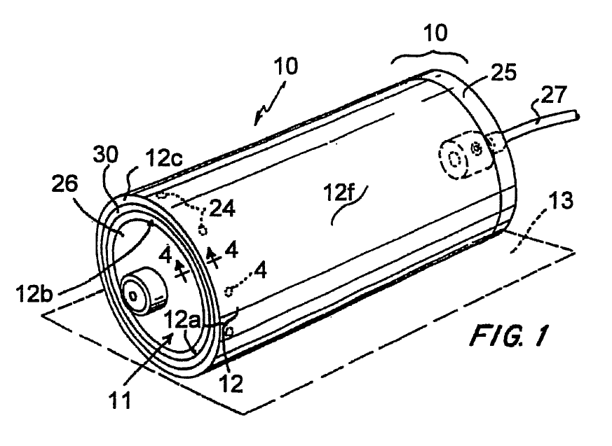

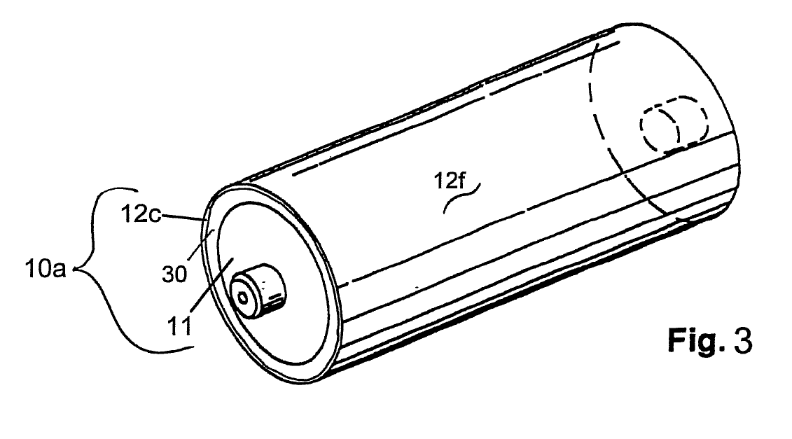

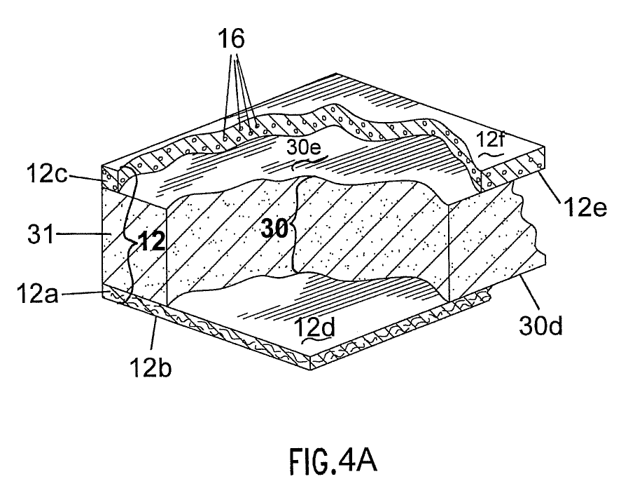

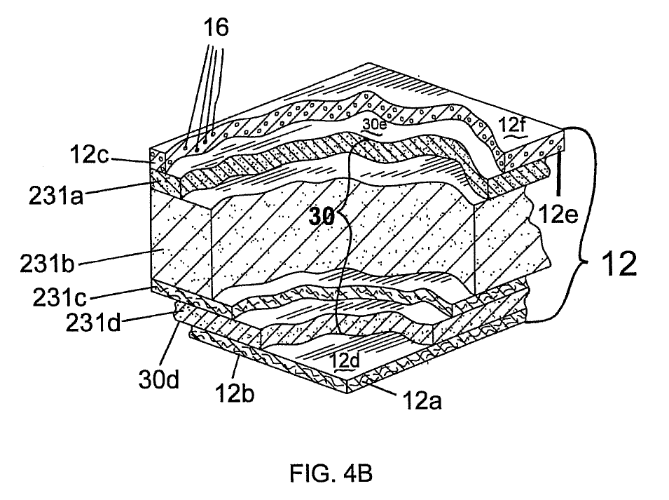

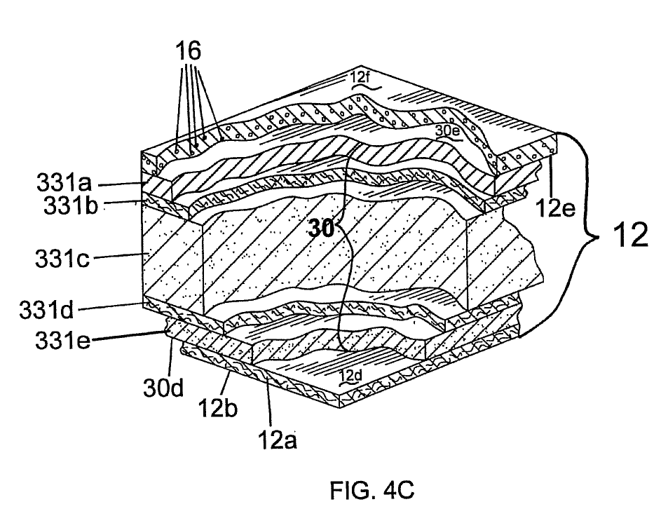

A presently preferred embodiment of a bridged blanket sleeve of the present invention is shown schematically in FIG. 1 and is represented generally by the numeral 12. A presently preferred embodiment of a bridged blanket mandrel of the present invention is shown schematically in FIG. 3 and is represented generally by the numeral 10a. As shown schematically in each of FIGS. 1 and 3, each of the respective bridged blanket sleeve 12 or bridged blanket mandrel 10a includes an outermost single blanket layer 12c and an intermediate bridge section 30 disposed beneath and supporting the single blanket layer 12c. As schematically shown in each of FIGS. 4A, 4B and 4C for example, the innermost cylindrically shaped surface 12e of the single blanket layer 12c is attached to the outermost cylindrically shaped surface 30e of the intermediate bridge section 30. Additionally, the innermost cylindrically shaped surface 30d of the intermediate bridge section 30 is attached to the outermost cylindrically shaped surface 12d of the innermost cylindrical portion 12a. Incidentally, the relative radial thicknesses of the single blanket layer 12c, the intermediate bridge section 30, the innermost cylindrical portion 12a and the diameter of the mandrel 11 are not drawn to scale in FIGS. 1, 3, 4A, 4B and 4C, as these drawings are for illustrative purposes and are not intended as engineering drawings.

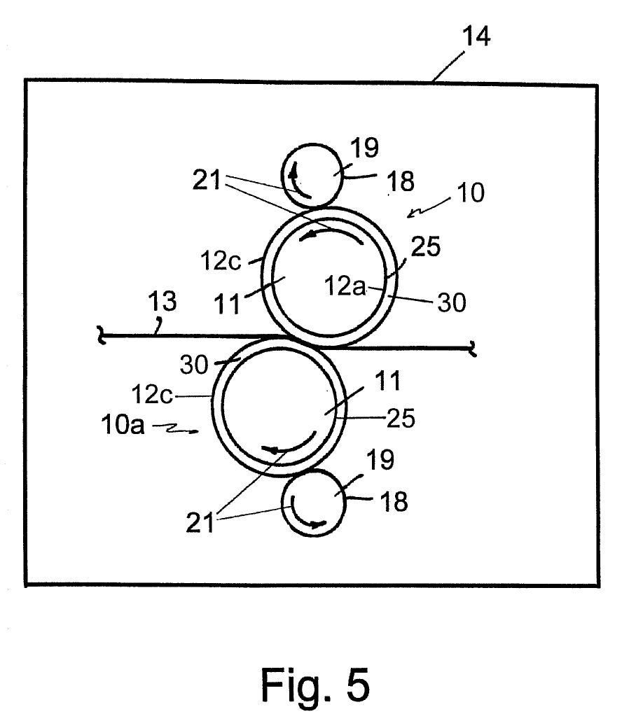

As shown in FIGS. 1 and 3 for example, the outer surface 12f of single blanket layer 12c is the outermost surface of the blanket sleeve 12 or blanket mandrel 10a and thus the surface that receives the ink (or other medium to be transferred) and transfers the ink to the substrate 13 (shown in dashed outline in FIG. 1) or other receiving surface. This cylindrically shaped outer surface 12f of the single blanket layer 12c is configured to cooperate directly with a lithographic plate (e.g., 18 in FIG. 5) carried by another cylinder (e.g., printing cylinder 19 in FIG. 5) of the printing machine 14 (FIG. 5), and with a substrate 13 (FIGS. 1 and 5), for example a web of paper or plastic, on which the printing is to be applied.

According to the presently preferred embodiments of the invention and as shown in FIGS. 4A, 4B and 4C for example, the single blanket layer 12c is the uppermost layer of the bridged blanket sleeve 12 and desirably is formed of polyurethane material. As schematically shown in each of FIGS. 4A, 4B and 4C for example, the single blanket layer 12c is composed of material that has an essentially uniform density over the radial thickness, the axial length and the circumferential dimension of the single blanket layer 12c. However, this single blanket layer 12c is processed in a manner that results in a density that is less than the density of polyurethane alone.

The polyurethane material for the single blanket layer 12c is preferably elastomeric and based on polyether or polyester. The choice between polyether and polyester may depend on what sorts of inks and solvents are likely to be encountered in the work environment. Polyester resists degradation in environments where alcohol is likely to be encountered. Polyether resists degradation in environments where acetates and acetone are likely to be encountered. It also might be possible to use polyurethane material based on hydroxyl-terminated polybutadienes to form the single blanket layer 12c.

More particularly, the single blanket layer 12c desirably is configured in a cylindrically shaped shell. The single blanket layer 12c desirably is formed with open cells or closed cells. As shown in each of FIGS. 4A, 4B and 4C for example, the single blanket layer 12c must be formed of polyurethane of cellular structure with internal cells or lower density regions 16 or cells 16 that desirably can be obtained by inserting into the polyurethane material a plurality of non-expanding microspheres, which thus become encapsulated within the single blanket layer 12c when the polyurethane material sets or cures. These microspheres are available from Expancel of Stockviksverken, Sweden, a subsidiary of Akzo Nobel, and sold under the Expancel® trade name. These microspheres comprise, for example, an outer skin mainly consisting of a copolymer of vinylidene chloride, acrylonitrile and/or methacrylate, or other similar thermoplastic resins. As used herein, a copolymer includes repeating units composed of two or more monomers. The outer skin also can be obtained from a thermosetting resin (e.g., of phenolic type). These microspheres desirably contain gaseous isobutene confined within the outer skin.

Alternatively, the aforesaid lower density regions 16 or cells 16 can be obtained by mixing the polyurethane with swelling agents followed by expansion. These agents are known per se (such as that known commercially as POROFOR available from Bayer AG, the well known manufacturer of chemicals headquartered in Germany) and develop nitrogen or other gases when heated. The developed gas expands to create the lower density regions 16 or cells 16 within the single layer 12c. The heat for this gaseous expansion desirably is provided by the exothermic reaction that occurs as the polyurethane material sets or cures.

In a further variant, the cells 16 can be obtained by mixing the polyurethane material with water-soluble salts such as sodium chloride or magnesium chloride or magnesium sulphate. The particles of these salts dispersed homogeneously within the polyurethane material are then removed by water, to generate a so-called “open cell” structure.

As shown in each of FIGS. 4A, 4B and 4C for example, the printing surface 12f is formed of the outermost cylindrically shaped exterior surface of the single layer 12c and thus is also composed of polyurethane. The cells 16 that interrupt the printing surface 12f become pores 16 that are so small as to be undetectable by the naked eye. The diameters of the cells 16 are in the same range as the diameters of the microspheres, namely, about 40 microns to about 80 microns. The single polyurethane blanket layer 12c has a desired density of about 0.7 kg/dm³. This density of the single blanket layer 12c is desirably in a range of between about 0.6 kg/dm³ and 0.8 kg/dm³. The exterior surface 12f of the single blanket layer 12c (printing surface) desirably has a hardness of between about 50° Shore A and about 75° Shore A, and more desirably between about 55° Shore A and about 65° Shore A, and more desirably between about 58° Shore A and about 62° Shore A, even more desirably about 60° Shore A. The exterior surface 12f of the single blanket layer 12c (printing surface) desirably has good resistance to wash solvents. The exterior surface 12f of the single blanket layer 12c (printing surface) desirably has an ultimate elongation in a range of about 110% to about 130% calculated by mechanical test at break. In practical terms, one can squeeze the blanket sleeve 12 between one's thumb and forefinger and feel the blanket sleeve 12 compress and spring back without any residual deformation of the printing surface 12f of the blanket sleeve 12.

In each case, in accordance with the present invention, when the precursor material is desirably 100 grams by weight polyol and 50 grams by weight cross-linking agent (isocyanate), as the amount of microspheres can vary between 1 gram and 6 grams, then the single layer 12c that desirably is formed by a cylindrical annulus formed of solid polyurethane has tiny cells 16 uniformly dispersed throughout such polyurethane, and those cells 16 constitute no less than about 0.65 percent by weight and no more than about 3.9 percent by weight of the single blanket layer 12c. Desirably, the weight of the microspheres that occupy the cells 16 in the single blanket layer 12c is from about one percent by weight to about three percent by weight. Desirably, the weight of the microspheres that occupy the cells 16 in the single blanket layer 12c is from about one percent by weight to about two percent by weight. Desirably the weight proportions in the single blanket layer 12c are about one and one-half percent microspheres and about ninety-eight and one-half percent polyurethane. Desirably the single blanket layer 12c has about 1.2 percent microspheres by weight and about 98.8 percent polyurethane by weight.

The sizes of the cells 16 are on the order of the sizes of the non-expanding microspheres that are used to generate the cells 16. As such as noted above, the cells 16 in the printing surface 12f have diameters averaging in the range of about 40 microns to about 80 microns and thus cannot be detected by the naked eye. Such a single blanket layer 12c provides surface tension that releases the ink and yet provides enough dimensional stability and compressibility for offset printing. Moreover, because of the unique single blanket layer 12c, it is believed that the commercially useful life of a bridged blanket sleeve 12 or bridged blanket mandrel 10a of the present invention will be on the order of six to ten times longer than the commercially useful life of a conventional rubber blanket.

As shown schematically in each of FIGS. 1 and 3, each of the respective bridged blanket sleeve 12 or bridged blanket mandrel 10a includes an intermediate bridge section 30 that is generally cylindrical in shape and that constitutes the middle portion of the bridged blanket sleeve 12 or bridged blanket mandrel 10a. The intermediate bridge section 30 of the bridged blanket sleeve 12 or bridged blanket mandrel 10a desirably contains one or more bridge layers that add radial thickness to the sleeve or mandrel.

As schematically shown in each of FIGS. 4a, 4B and 4C, the outermost single blanket layer 12c is disposed on and integrally attached to the outer cylindrical surface 30e of the intermediate bridge section 30. Thus, the outer cylindrical surface 30e of the intermediate bridge section 30 must be sufficiently rigid to form an adequate support surface for the single blanket layer 12c. As used herein, the term “rigid” refers to a material having a certain Shore hardness.

At air pressures between about 80 to about 90 psi, the inner surfaces 12b of bridged blanket sleeves 12 typically are expected to expand in a radial direction between about 0.038 to about 0.114 mm, and in some embodiments between about 0.0635 to about 0.0889 mm. In an embodiment of a bridged blanket sleeve 12 having a diameter less than 200 mm, the inner surface 12b of such bridged blanket sleeve 12 is expected to expand in a radial direction about 0.0635 mm. Moreover, in another embodiment, a bridged blanket sleeve 12 having an inner diameter greater than 200 mm, the inner surface 12b of such bridged blanket sleeve 12 is expected to expand in a radial direction about 0.0889 mm.

Accordingly, the innermost cylindrical surface 30d of the intermediate bridge section 30 may need to be relatively expandable in order to accommodate the need to be mountable on a mandrel of a particular machine by the application of air pressure under the sleeve. As used herein, the term “expandable” refers to a material that can expand a certain radial distance upon the application of air at a certain pressure, typically between about 80 to about 100 psi.

The radially measured thickness of such intermediate bridge layers varies depending on the particular image repeat utilized. In most embodiments, for example, the radially measured thickness of the one intermediate bridge section 30 will vary from about 2.5 mm to about 200 mm. The combined radial thickness of such intermediate bridge layers is typically less than 80 mm.

If the increased diameter of the bridged blanket sleeve 12 necessary to achieve the desired repeat can be accomplished with a radial thickness of no more than about 5 millimeters for the bridged blanket sleeve 12, then a construction such as shown in FIG. 4A is believed desirable. In embodiments in which the intermediate bridge section 30 is formed by a single intermediate bridge layer 31 as schematically shown in FIG. 4A, the radially measured thickness of the one intermediate bridge layer 31 desirably is about 2.5 mm to about 3.5 mm. In embodiments in which the intermediate bridge section 30 is formed by a several intermediate bridge layers as schematically shown in FIGS. 4B and 4C, the radially measured thickness of the combined several intermediate bridge layers desirably is about 3.5 mm to about 80 mm but can stretch to up to about 200 mm.

As schematically illustrated in FIG. 4A, an embodiment of the blanket sleeve desirably includes an intermediate bridge section 30 having only a single intermediate bridge layer 31. The radially measured thickness of this embodiment of the overall bridged blanket sleeve 12 measured from the innermost cylindrical surface 12b of the innermost cylindrical layer 12a to the outermost cylindrical surface 12f of the single blanket layer 12c desirably measures about 0.200 inches (5.08 mm). The radially measured thickness of the single bridge layer 31 of this embodiment of the bridged blanket sleeve 12 schematically illustrated in FIG. 4A measured from the uppermost cylindrical surface 30e of the single bridge layer 31 to the innermost cylindrical surface 30d of the single bridge layer 31 desirably measures about 2.0 mm to about 4.0 mm and desirably is about 3.5 mm.

In this single bridge layer embodiment schematically illustrated in FIG. 4A, the single intermediate bridge layer 31 having a radial thickness in the range of about 2.0 mm to about 4.0 mm must be both rigid and relatively expandable. The rigidity of the single bridge layer 31 is believed necessary in order to maintain the required characteristics of the outermost surface 12e of the single blanket layer 12c. The expandability of the single bridge layer 31 is believed necessary to accommodate the required radial expansion of the innermost cylindrical core layer 12a that is needed to enable the bridged blanket sleeve 12 to be mounted onto an air pressurized blanket mandrel 11 of an offset printing machine. In one presently desirable embodiment schematically shown in FIG. 4A for example, the single intermediate bridge layer 31 can be made from a generally rigid, relatively expandable polyurethane material having a Shore D hardness of about 75 to about 85 and desirably having a Shore D hardness of about 80. One such polyurethane material may be obtained from H.B. Fuller Austria under the tradename ISA-PUR 3040. Another such polyurethane material may be obtained from Rampf of Germany and Wixom, Mich. under the tradename RAKU-PUR 30-2003-19A.

Moreover, as the radial thickness of the intermediate bridge section 30 that is needed to obtain a blanket surface 12f able to accommodate the desired repeat increases, some embodiments of the bridged blanket sleeve 12 or bridged blanket mandrel 10a can include an intermediate bridge section 30 that contains more than one intermediate bridge layer. In such embodiments such as schematically shown in FIGS. 4B and 4C, the multiple intermediate bridge layers forming the intermediate bridge section 30 can be used to add further thickness to the sleeve or mandrel. In general, any number, size, shape, and/or type of the intermediate bridge layers forming the intermediate bridge section 30 can be used in the present invention, so long as the resulting blanket sleeve 12 can be air-mounted onto a spindle or mandrel of the printing machine and the blanket surface 12f maintains its desired characteristics. Examples of some materials suitable in forming the multiple intermediate bridge layers that form the intermediate bridge section 30 include, but are not limited to, aramid fiber bonded with epoxy resin or polyester resin; reinforced polymeric material such as hardened glass fiber bonded with epoxy resin or polyester resin, the latter two also known as fiberglass reinforced epoxy resin or fiberglass reinforced polyester; DUPONT® MYLAR® or tri-laminate KEVLAR®; NOMEX® which is sold by DUPONT; honeycomb structures; a polyurethane material (e.g., from H.B. Fuller Austria under the tradename ISA-PUR 3030 or the tradename ISA-PUR 3040 and from Rampf of Germany under the tradename RAKU-PUR 30-2003-19A or the tradename RAKA-PUR 34-C 164/18-3A); elastomeric rubber materials; elastomeric polyurethane materials; polyurethane expanded foam; open cell polyurethane foam; either an open-cell or closed-cell polyurethane foam tape supplied by 3-M Corp., Tesa AG, Rogers Corp. or Indiana Gummi, GmbH; aluminum; nickel; copper; carbon-reinforced epoxy resin; and the like.

Once the radial thickness required to accommodate the desired repeat exceeds about 5 millimeters, then one of the constructions shown schematically in FIGS. 4B and 4C desirably should be used. In each of these embodiments shown schematically in FIGS. 4B and 4C, the majority of the radial thickness desirably is achieved by a respective bridge layer 231b, 331c having a Shore D hardness of about 30, which will have the lowest density of any of the bridge layers composing the intermediate bridge section 30. Desirably, the respective bridge layer 231b, 331c having a Shore D hardness of about 30 is formed of polyurethane foam and is also referred to as the central spacer layer 231b, 331c. One such polyurethane material having a Shore D hardness of about 30 to about 50 may be obtained from H.B. Fuller Austria under the tradename ISA-PUR 3030. Another such polyurethane material may be obtained from Rampf under the tradename RAKA-PUR 34-C 164/18-3A).

An embodiment of the blanket sleeve of the present invention from which a section is schematically shown in FIG. 4B includes an intermediate bridge section 30 that includes a first intermediate bridge layer 231a, a second intermediate bridge layer 231b, a third intermediate bridge layer 231c, and a fourth intermediate bridge layer 231d. The first intermediate bridge layer 231a provides a blanket support layer that desirably can be formed of a polyurethane foam material having a Shore D hardness of about 80 and disposed between the single blanket layer 12c and the second bridge layer 231b. This embodiment shown schematically in FIG. 4B desirably might include in addition to the blanket support layer 231a, a second bridge layer 231b to provide a central spacer layer that desirably can be formed with a Shore D hardness in a range of about 30 to about 50 and more particularly of about 30. The central spacer layer 231b desirably provides the bulk of the radial thickness that the intermediate bridge section 30 furnishes to the overall bridged blanket sleeve 12 and typically is the least dense of the bridge layers that compose the intermediate bridge section 30.

The fourth intermediate bridge layer 231d schematically shown in FIG. 4B provides a base bridge layer, which desirably is relatively expandable and disposed against the innermost tubular cylindrical core layer 12a. The base bridge layer 231d desirably can be formed of a polyurethane foam material having a Shore A hardness in a range of about 30 to about 50 and particularly about 40.

The base bridge layer 231d is desirably provided by an open-cell or closed-cell polyurethane foam tape that is disposed between the innermost tubular cylindrical core layer 12a and a third intermediate bridge layer 231c that provides a joining bridge layer. An open-cell or closed-cell polyurethane foam tape material having a Shore A hardness in a range of about 30 to about 50 can be supplied by either 3-M Corp., Tesa AG, Rogers Corp. or Indiana Gummi, GmbH.

As schematically shown in FIG. 4B, the joining bridge layer 231c is disposed between the central spacer bridge layer 231b and the base bridge layer 231d. Each of the joining bridge layer 231c and the cylindrical core layer 12a desirably can be formed with a Shore D hardness of about 90 from one of the following materials: aramid fiber bonded with epoxy resin or polyester resin; reinforced polymeric material such as hardened glass fiber bonded with epoxy resin or polyester resin, the latter two also known as fiberglass reinforced epoxy resin or fiberglass reinforced polyester; NOMEX® which is sold by DUPONT; honeycomb structures; and DUPONT® MYLAR® or tri-laminate KEVLAR®.

In some embodiments such as schematically shown in FIG. 4C, a metal outer layer can be used as the uppermost bridge layer of the intermediate bridge section 30. The metal layer 331a provides the necessary rigidity to form the blanket support layer. The metal layer 331a desirably can be formed of an aluminum extruded layer that provides the necessary rigidity without being unduly heavy in weight.

In an embodiment that would include multiple bridge layers as shown schematically in FIG. 4C, this embodiment desirably might include a blanket support bridge layer 331a in the form of an aluminum extruded layer, a second intermediate bridge layer 331b, a third intermediate bridge layer 331c, a fourth intermediate bridge layer 331d and a fifth intermediate bridge layer 331e. This embodiment shown schematically in FIG. 4C desirably might include in addition to the metal blanket support bridge layer 331a, a central spacer layer 331c that desirably can be formed with a Shore D hardness of about 30. The central spacer layer 331c desirably provides the bulk of the radial thickness that the intermediate bridge section 30 furnishes to the overall bridged blanket sleeve 12 and typically is the least dense of the bridge layers that compose the intermediate bridge section 30. One such polyurethane material having a Shore D hardness of about 30 to about 50 may be obtained from H.B. Fuller Austria under the tradename ISA-PUR 3030. Another such polyurethane material may be obtained from Rampf under the tradename RAKA-PUR 34-C 164/18-3A).

The fifth intermediate bridge layer 331e provides a base bridge layer, which desirably is relatively expandable and disposed against the innermost tubular cylindrical core layer 12a. The base bridge layer 331e desirably can be formed of a polyurethane foam material having a Shore A hardness of about 40. The base bridge layer 331e is disposed between the innermost tubular cylindrical core layer 12a and a fourth intermediate bridge layer 331d that provides a joining bridge layer. The base bridge layer 331e is desirably provided by an open-cell or closed-cell polyurethane foam tape material having a Shore A hardness in a range of about 30 to about 50, and such tape can be supplied by either 3-M Corp., Tesa AG, Rogers Corp.or Indiana Gummi, GmbH.

As schematically shown in FIG. 4C, a joining bridge layer 331d is disposed between the central spacer bridge layer 331c and the base bridge layer 331e. As schematically shown in FIG. 4C, another joining bridge layer 331b is disposed between the central spacer bridge layer 331c and the metal blanket support bridge layer 33a. Each of the joining bridge layers 331b, 331d and the cylindrical core layer 12a desirably can be formed with a Shore D hardness of about 90 from one of the following materials: aramid fiber bonded with epoxy resin or polyester resin; reinforced polymeric material such as hardened glass fiber bonded with epoxy resin or polyester resin, the latter two also known as fiberglass reinforced epoxy resin or fiberglass reinforced polyester; NOMEX® which is sold by DUPONT; honeycomb structures; and DUPONT® MYLAR® or tri-laminate KEVLAR®.

With reference to FIG. 1, a bridged blanket cylinder for an offset printing machine is indicated overall by the numeral 10 and comprises a rotary support or mandrel 11 over which a layered bridged blanket sleeve 12 can be drawn. The mandrel/sleeve system can be either of two types. In one type, the inner diameter of the bridged blanket sleeve 12 remains fixed, and the outer diameter of the mandrel 11 expands and contracts (usually with the aid of an hydraulic system) to permit mounting and dismounting of the bridged blanket sleeve 12 to the mandrel 11. In another type, the outer diameter of the mandrel 11 remains fixed, and the inner diameter of the bridged blanket sleeve 12 expands and contracts (usually with the aid of a compressed air system) to permit mounting and dismounting of the sleeve 12 to the mandrel 11.

As an example of the latter type, the mandrel 11 shown in FIG. 1 is of known type provided with internal ducts (not shown) that extend axially and open at 24 onto a free surface 25 of the mandrel at one end 26 of the mandrel 11. A pipe 27 connected to the mandrel 11 supplies compressed air through the openings 24 via these ducts and thus carries pressurized air onto the surface 25 of the mandrel 11. By virtue of this pressurized air that provides enough force to slightly, radially deform the inner hollow surface of the bridged blanket sleeve 12, the bridged blanket sleeve 12 can be drawn over the outer cylindrical surface 25 of the mandrel 11 as a person's sock is drawn over the person's foot.

In general, as schematically shown in FIG. 1 for example, the bridged blanket sleeve 12 includes an innermost core layer 12a that is generally cylindrical in shape and that constitutes the innermost portion of the bridged blanket sleeve 12. In some embodiments, the core layer 12a of the bridged blanket sleeve is formed of an expandable, high rigidity material. Some examples of compositions that are suitable for use in the core layer 12a include, but are not limited to, aramid fiber bonded with epoxy resin or polyester resin; reinforced polymeric material such as hardened glass fiber bonded with epoxy resin or polyester resin, the latter two also known as fiberglass reinforced epoxy resin or fiberglass reinforced polyester; NOMEX® which is sold by DUPONT; honeycomb structures; DUPONT® MYLAR® or tri-laminate KEVLAR®; carbon-reinforced epoxy resin; nickel; copper; and the like. The radial thickness of the core layer 12a can, in some embodiments, be between about 0.020 to about 0.100 inches (0.508 to 2.54 mm), with the larger thickness being used for sleeves with greater diameters and/or axial lengths.

As shown in FIG. 1, the core layer 12a of the bridged blanket sleeve 12 comprises an inner tubular cylindrical portion 12a arranged to cooperate directly with the outer surface 25 of the mandrel 11. The cylindrical portion 12a has a through longitudinal bore that presents a cylindrically shaped inner surface 12b configured to cooperate with the mandrel's cylindrical outer surface 25.

In embodiments requiring the cylindrical portion 12a to expand in order to be mounted on the rotary mandrel 11, the material forming the cylindrical portion 12a cannot be so thick that it is rendered unable to expand sufficiently to be mounted on the mandrel 11 when the compressed air is applied to the elastic cylindrical portion 12a through the openings 24. Compressed air desirably is provided in a range of about 6 bar to about 8 bar and more desirably about 6 bar is provided. The elasticity of the cylindrical portion 12a that forms the inner core of the blanket sleeve 12 can be related to the radial thickness of the cylindrical portion 12a, which in some embodiments can have a radial thickness between about 0.1 mm and about 2.0 mm when intended to be expandable and depending on the material used for its construction.

More particularly, when intended for mounting on a rotary mandrel 11 of fixed diameter, the inner cylindrical portion 12a (aka inner core 12a) is constructed of material sufficiently elastic to enable the cylindrical portion 12a itself to elastically expand radially by a minimum amount to enable it to be mounted on the mandrel 11. If the cylindrical portion 12a is constructed of a thin cylindrical shell formed of nickel, then the cylindrical portion 12a desirably should have a radial thickness in a range of about 0.1 mm to about 0.5 mm and desirably in a range of between about 0.1 mm and about 0.25 mm. The radial thickness of the nickel shell 12a desirably can be in a range of about 0.127 mm to about 0.228 mm and desirably is about 0.178 mm.

However, the cylindrical portion 12a alternatively can have a composite structure of resins and fiber glass. Examples of compositions that are suitable for composing the cylindrical portion 12a include one of the group consisting of aramid fiber bonded with epoxy resin or polyester resin, and reinforced polymeric material such as hardened glass fiber bonded with epoxy resin or polyester resin, the latter two also known as fiberglass reinforced epoxy resin or fiberglass reinforced polyester. If the cylindrical portion 12a is constructed of a thin cylindrical shell formed of resins and fiber glass, then the cylindrical portion 12a desirably should have a radial thickness desirably in a range of about 0.3 mm to about 1.0 mm and particularly in a range of about 0.5 mm to about 0.8 mm. A radial thickness of about 0.5 mm should work well for a cylindrical portion 12a formed of resins and fiber glass for sleeves 12 that are to be used on Heidelberg offset printing machines. A radial thickness of about 0.8 mm should work well for a cylindrical portion 12a formed of resins and fiber glass for sleeves 12 that are to be used on MAN Roland offset printing machines.

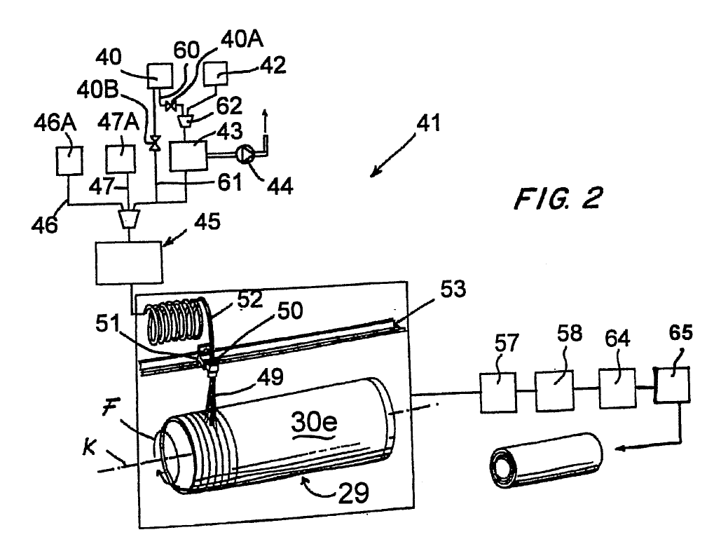

Alternatively, when intended for mounting on a rotary mandrel of changeable diameter, the cylindrical core portion 12a desirably is constructed of material sufficiently inelastic to enable the cylindrical core portion 12a to retain a fixed diameter under pressure from the expanding mandrel. In this case, the cylindrical portion 12a desirably is constructed of a composite structure of graphite impregnated plastics or of resins and fibers such as carbon fibers. In the latter, the carbon fiber is desirably oriented parallel to the rotational axis K (FIG. 2) in order to provide the inner core 12a with maximum rigidity. The cylindrical core portion 12a also can be constructed of a strip of metal or rigid polyurethane with a hardness exceeding 70° Shore D. The cylindrical body that defines the inner cylindrical core portion 12a of the bridged blanket sleeve 12 also can be provided by a steel cylinder or an aluminum tube or an aluminum clad sleeve.

Instead of an innermost core layer 12a that constitutes the innermost portion of the bridged blanket sleeve 12, the bridged blanket mandrel 10a substitutes the outer surface 25 of a mandrel 11 as shown schematically in FIG. 3. In this case, the outer surface 25 of the mandrel 11 takes the place of the outer surface 12d of the inner core 12a of the bridged blanket sleeve 12.

The embodiment of the blanket sleeve 12 described above is of the type that is independent of the mandrel 11. The typical dimensions of a finished bridged blanket sleeve 12 has an internal diameter of the cylindrically shaped inner surface 12b on the order of about 15 cm to about 20 cm. A typical finished bridged blanket sleeve 12 might have an axial length of about 150 cm to about 210 cm. The radial thickness of a typical embodiment of a bridged blanket sleeve 12, including the core layer 12a, the intermediate bridge section 30 and the single blanket layer 12c, would measure in a range of about 15 mm about to about 200 mm.

The ideal radial thickness of the bridged blanket sleeve is believed to be somewhat dependent on the source of the offset printing machine on which the bridged blanket sleeve 12 is to be used and the printing job for which it is intended.

A typical radial thickness of a core layer 12a made of nickel is about 0.5 mm, and a thickness of about 1 mm to about 2 mm for the single blanket layer 12c would be typical for such a bridged blanket sleeve 12 or a bridged blanket mandrel 11. These dimensions are not meant to limit the dimensions of the bridged blanket sleeves 12 or mandrels 11 but are merely provided as examples of dimensions that are believed to be useful for printing jobs currently being done in the industry. With such dimensions, the bridged blanket sleeve 12 can be transported easily (by virtue of its relatively light weight in comparison to a mandrel 11) and can be drawn over the mandrel 11 to form the bridged blanket cylinder 10. FIG. 5 schematically illustrates a printing machine 14 with particular emphasis on a bridged blanket cylinder 10 and a bridged blanket mandrel 10a shown in relation to a printing cylinder 19 having a lithographic plate 18. The arrows designated 21 schematically indicate the direction of rotation of the bridged blanket mandrel 10a and bridged blanket cylinder 10 during printing operation of the machine 14. Though it would be unusual for such a pair to be employed to print on opposite sides of a substrate 13, they are so presented in FIG. 5 for purposes of illustrating the two types of configurations employing the inventive single blanket layer 12c. As shown in FIGS. 1 and 5 for example, a bridged blanket sleeve 12 can become an integral part of the mandrel 11 when the bridged blanket sleeve 12 becomes stably locked to the surface 25 of the mandrel 11 to form the bridged blanket cylinder 10 shown in FIGS. 1 and 5 for example. In this case, the inner cylindrical portion 12a described in relation to FIG. 1 non-rotatably mates with the mandrel 11 to form the bridged blanket cylinder 10. Alternatively, the intermediate bridge section 30 shown in FIGS. 3 and 5 can be formed directly on the outer surface 25 of the mandrel 11 and thus carried by the mandrel 11 to form the bridged blanket mandrel 10a shown in FIGS. 3 and 5 for example. In this latter case, the outer surface 25 of the bridged blanket mandrel 10a takes the place of the outer surface 12d of the inner core 12a of the bridged blanket sleeve 12.

The production of an embodiment of a bridged blanket sleeve 12 of the type that can be drawn over a rotary mandrel 11, now will be described with reference initially to FIG. 2.

In producing the bridged blanket sleeve 12, a cylindrical body is provided to define the inner cylindrical portion 12a (aka core) of the blanket sleeve 12 shown in each of FIGS. 4A, 4B and 4C. The inner cylindrical portion 12a is obtained by methods that are known per se and therefore not described. Reference is made for example to commonly owned U.S. Pat. No. 7,308,854, which is hereby incorporated herein in its entirety for all purposes by this reference. Moreover, the production of the inner cylindrical portion 12a can be at least largely automatic and independently precede the production of the rest of the bridged blanket sleeve 12.

The intermediate bridge section 30 of the sleeve 12 can include one or more of the different layers described above, and presently preferred embodiments are illustrated schematically in each of FIGS. 4A, 4B and 4C. In the embodiment of FIG. 4A for example, the single intermediate bridge layer 31 forming the entire intermediate bridge section 30 desirably can be formed from a polyurethane material having a Shore D hardness from about 75 to about 85. One such polyurethane material may be obtained from H.B. Fuller Austria under the tradename ISA-PUR 3040. Another such polyurethane material may be obtained from Rampf of Germany and Wixom, Mich. under the tradename RAKU-PUR 30-2003-19A. Moreover, this single intermediate bridge layer 31 can be formed around the inner cylindrical portion 12a by methods that are known per se and therefore need not be described beyond this reference.

Once the desired intermediate section 30 is completely formed, then the single blanket layer 12c desirably can be formed integrally with the uppermost cylindrical surface 30e of the single bridge section 30 as schematically shown in each of FIGS. 4A, 4B and 4C.

The single blanket layer 12c is formed from a runny polyurethane precursor material. When fully mixed together and ready to be dispensed as a runny polyurethane precursor material, the runny polyurethane precursor material desirably will consist essentially of by weight proportions: about 100 parts polyol, about 50 parts isocyanate (curing agent), about 1.8 parts microspheres and about 3 parts thixotropic agent. The density of the runny polyurethane precursor material is desirably in a range of between about 0.6 kg/dm³ and about 0.8 kg/dm³ and desirably is about 0.7 kg/dm³. The polyol is preferably elastomeric such as a polyether polyurethane or a polyester polyurethane. These polyols are available from Bayer AG of Germany and from Chemtura Corporation of Middlebury, Conn. (formerly Uniroyal Chemical Corporation). It also might be possible to use hydroxyl-terminated polybutadienes as a polyol precursor material to form the single layer 12c.

The isocyanate is available from Dow Chemical Company of Midland, Michigan. Additionally, the weight proportion of isocyanate can be varied from the 50 parts to proportionately vary the Shore A hardness of the finished single outer layer of the blanket sleeve such that each part above or below 50 parts will translate roughly into 3 or 4 points above or below, respectively, in the Shore A hardness of the finished single outer blanket layer 12c of the bridged blanket sleeve 12.

As schematically shown in FIG. 2, after the fabrication of the intermediate bridge section 30, a first tank 40 of a plant 41 can be filled with the polyol used for preparing the polyurethane precursor material to obtain the single blanket layer 12c. Some examples of suitable polyols also can be found in U.S. Pat. No. 5,648,447, which is hereby incorporated herein in its entirety for all purposes by this reference. First tank 40 can be provided with a mixture of the polyol already combined with the suitable portion of the thixotropic agent. Moreover, as explained below, first tank 40 can be provided with a mixture of the polyol already combined with the suitable portion of the thixotropic agent and the desired proportion by weight of microspheres. Such a mixture of the polyol already combined with the suitable portion of the thixotropic agent and the desired proportion by weight of microspheres is available from the Rampf Group of Germany, which has a subsidiary in Wixom, Mich. Desirably, the weight of microspheres in the polyol portion is from about one percent by weight to about six percent by weight. Desirably, the weight of microspheres in the polyol portion is from about one percent by weight to about three percent by weight. Desirably, the weight of microspheres in the polyol portion is from about one percent by weight to about two percent by weight. Desirably the weight proportions are about 1.8 percent (1.8%) microspheres and about 98.2 percent (98.5%) polyol.

As schematically shown in FIG. 2, a first tank 40 is connected to a first mixer head 62 via a line 60. A valve 40A in line 60 can be opened or closed to control whether any flow occurs through line 60 from first tank 40 to first mixer head 62. A line 61 also leads from first tank 40 and has a valve 40B that can be opened or closed to control whether any flow occurs through line 61 from first tank 40. A suitable quantity of microspheres can be fed into a second tank 42, which is also connected by another line to first mixer head 62. Yet another line connects first mixer head 62 to a mixing chamber 43, which can be placed under vacuum by a vacuum pump 44. Without the vacuum, the microspheres are so small (diameters averaging in the range of about 40 microns to about 80 microns) and light in weight that they would not otherwise flow solely under the influence of gravity. The density of the microspheres is about 0.03 kg/dm³. The operation of the first mixer head 62, the valves 40A, 40B and pump 44 can be controlled automatically and remotely as by computerized process controls for example.

In one embodiment of the process, valve 40B is closed and valve 40A is opened. The polyol product (with thixotropic agent) contained in first tank 40 and the microspheres contained in second tank 42 are fed into first mixer head 62. The mixed product of polyol and microspheres leaving first mixer head 62 is drawn into mixing chamber 43 by vacuum pump 44. The desired quantity of microspheres that is fed into mixing chamber 43 is such that it generally becomes the desired proportion by weight of the polyol precursor material. Desirably, for every 100 grams of polyol, the weight of microspheres in the polyol portion is from about one gram to about six grams. Desirably, for every 100 grams of polyol, the weight of microspheres in the polyol portion is from about one gram to about three grams. Desirably, for every 100 grams of polyol, the weight of microspheres in the polyol portion is from about one gram to about two grams. Desirably, for every 100 grams of polyol, the weight of microspheres is about 1.8 grams. It is critical that for every 100 grams of polyol, the microspheres must constitute no less than about one gram and no more than about six grams in mixing chamber 43. The weight proportion of microspheres can be varied within this range of about one gram to about six grams in order to vary the compressibility of the final blanket sleeve that is desired.

Alternatively, valve 40A is closed and valve 40B is opened. The microspheres can be mixed with the polyol outside of the production cycle. In this alternative case, the base solution in first tank 40 comprises precursor material of polyol already mixed with microspheres so that the weight proportion of microspheres will be in a desired range of the weight proportion of the polyol. As noted above, such a mixture of the polyol already combined with the suitable portion of the thixotropic agent and the desired proportion by weight of microspheres can be obtained from the Rampf Group of Germany, which has a subsidiary in Wixom, Mich.

A mixing member 45 (or simply mixer) is basically a small chamber having a rotor for mixing and is provided with two basic components. One of the components is the above-noted precursor material of polyol mixed with microspheres, which is a runny product such that it will run off of a stick that is dipped into it. The above-noted precursor material of polyol mixed with microspheres that leaves the chamber 43 (or first tank 40 in the alternative embodiment) is fed into mixing member 45. This first component also can include other ingredients, as desired, such as pigments, fillers, diamines, and catalysts. The second component is primarily the cross-linking element (such as isocyanate), but can include a thixotropic agent (such as an amine) if not already supplied in the solution contained in first tank 40. The density and viscosity of the cross-linking element (such as isocyanate) are very close to the density and viscosity of the first component consisting of polyol mixed with microspheres. As shown schematically in FIG. 2, line 46 feeds into mixer 45 from tank 46A containing a cross-linking element. Diphenyl methane-4-4-diisocyanate (also known as MDI) is a suitable cross-linking element, which is believed readily available from Dow Chemical Company of Midland, Mich. Similarly, line 47 feeds into mixer 45 from tank 47A, which can contain a thixotropic cross-linking agent such as an amine.

The first component is the main component by weight provided to mixer 45. The ratio by weight of the first component (polyol mixed with microspheres) to the second component (combination of the cross-linking element and the thixotropic agent) is desirably in the range of about 70% to 30% to about 65% to 35% and desirably in the range of about 100:30 to 100:60 and desirably in a ratio of 100 parts by weight of the first component (polyol mixed with microspheres) to 52 parts by weight of the second component (combination of the cross-linking element and the thixotropic agent). The bridged blanket sleeve's desired characteristics of hardness, resilience, reboundability, solvent resistance, and mechanical characteristics can be tailored by changing the chemical structure of the two components. The weight percentage of cells 16 in the final cured single polyurethane blanket layer 12c of the bridged blanket sleeve 12 depends on the proportion of microspheres mixed with the polyol and the weight ratio of the first component (polyol mixed with microspheres) to the second component (combination of the cross-linking element and the thixotropic agent).

Note that the various components combine in the mixer 45 to form a runny product. As shown schematically in FIG. 2, the runny product 49 leaves the mixer 45 via a line 52 to be deposited on the outer cylindrical surface 30e of the intermediate bridge section 30 according to ribbon flow technology. During deposition, a precursor sleeve 29 consisting of the intermediate section 30 integrally connected to the innermost cylindrical core layer 12a is rotated about its axis K as schematically shown by the arrow F in FIG. 2. The nozzle 50 and the precursor sleeve 29 desirably are movable with respect to each other in traversing axial movements. As schematically shown in FIG. 2 for example, the nozzle 50 can be associated with a carriage 51 (to which a hose 52 is connected from the mixer 45) that is movable along a straight guide 53 arranged parallel to the axis K of the precursor sleeve 29.

Desirably, the runny product is dispensed from nozzle 50 in the form of a continuous ribbon 49 as opposed to a spray that contains discontinuous droplets entrained in a gas. As shown schematically in FIG. 2, the runny product 49 can be fed via line 52 to a nozzle 50 that is configured to deposit a continuous ribbon of the runny product 49 directly onto the outer cylindrical surface 30e of the precursor sleeve 29. As the runny product 49 is applied onto the outer surface 30e of the precursor sleeve 29, the runny product 49 undergoes an exothermic chemical reaction and immediately begins formation of the cross-linked polyurethane blanket layer 12c that adheres to the outer surface 30e of the intermediate bridge section 30 without the aid of adhesives, regardless of whether the upper surface 30e is formed of an aluminum or nickel shell or a polyurethane foam layer of 80 Shore D hardness. Within a minute or two after being dispensed from the nozzle 50, the runny flowing ribbon 49 has solidified.

The runny product 49 leaving the mixer 45 is deposited in one or more passes on the cylindrical outer surface 30e of the intermediate bridge section 30. Typically, a single pass of the nozzle 50 down the length of the intermediate bridge section 30 while the precursor sleeve 29 is rotating about its longitudinal axis K is sufficient to form the single blanket layer 12c. The rate at which the ribbon of the runny product 49 is dispensed from the nozzle desirably can be on the order of about 2.5 grams per second. Thus, in about 10 minutes, enough of the runny polyurethane material 49 can be dispensed in a single pass of the nozzle 50 down the length of the precursor sleeve 29 to form an entire bridged blanket sleeve 12 measuring about 150 centimeters long and having a single polyurethane blanket layer 12c with a radial thickness of about 2 millimeters.

On termination of deposition of the runny product 49, the solidified runny product 49 deposited on the cylindrical upper surface 30e of the intermediate bridge section 30 is allowed to cool to room temperature. The cooling step can take anywhere from about 15 minutes to an hour or so and is indicated schematically by the block 57 of FIG. 2.

While the runny product 49 deposited on the upper cylindrical surface 30e of the intermediate bridge section 30 sets and solidifies in about one minute or two minutes to the point where it no longer is flowable, it is desirable to let the single blanket layer 12c cure (cross-link) for about 24 hours to about 48 hours before beginning to grind the surface to a parallel condition. This cross-linking or curing step can be carried out to form the cells 16 in the single blanket layer 12c, and the curing step is indicated schematically by the block 58 of FIG. 2. For those microspheres partially exposed at the uppermost surface 12f of the single polyurethane blanket layer 12c, the heat that is released during cross-linking can cause the outer skins of the microspheres to degrade and burst to create the pores 16 in the surface 12f, which pores 16 remain after the heat dissipates.

The density of the cured single polyurethane blanket layer 12c is desirably in a range of between about 0.6 kg/dm³ and about 0.8 kg/dm³ and desirably is about 0.7 kg/dm³. When the curing step has passed, the outermost surface 12f of the single blanket layer 12c is parallel ground to the desired radial dimension. This grinding step is indicated schematically by the block 64 of FIG. 2. The purpose of this grinding is to achieve a parallel exterior surface 12f as well as to obtain a desired radial thickness of the single blanket layer 12c, which is integrally attached to the cylindrical upper surface 30e of the intermediate section 30.

After the grinding step performed on the single blanket layer 12c, then the exterior surface 12f of single blanket layer 12c desirably can be polished by machine or manually to an average metric surface roughness in a range of about 1.0 Ra micrometer to about 7.0 Ra micrometers and desirably in a range of about 3.0 Ra micrometers to about 5.0 Ra micrometers. If polished by machine, the exterior surface 12f of single blanket layer 12c desirably can be felt polished. If polished manually, the exterior surface 12f of single blanket layer 12c desirably can be polished manually using 800 grit sand paper. The block 65 of FIG. 2 schematically indicates the polishing step to thus obtain the final product in the form of bridged blanket sleeve 12 with exterior surface 12f.

The aforesaid method can be implemented automatically or largely automatically. However, it may be economically more desirable to effect the manual manipulation of the bridged blanket sleeve 12 rather than machine handling of the bridged blanket sleeve 12, for surface grinding of the outermost surface of the precursor layer to the finished single layer 12c.

The finished outer diameter of the bridged blanket sleeve 12 has a tolerance of plus 0.02 mm and minus 0.01 mm. The total indicated runnout (TIR, indicative of the degree to which the surface is out of round) of the finished outer surface 12f of the bridged blanket sleeve 12 is a maximum of 0.02 mm.

The single blanket layer 12c is formed desirably with a hardness of about Shore A 60° and a density of about 0.7 kg/dm³. The density of the single blanket layer 12c is desirably in a range of between about 0.6 kg/dm³ and about 0.8 kg/dm³. The exterior surface (printing surface) 12f of the single polyurethane blanket layer 12c of the bridged blanket sleeve 12 desirably has a hardness of between about 50° Shore A and about 75° Shore A, and desirably between about 58° Shore A and about 62° Shore A. The single blanket layer 12c has an elongation in the range of about 110% to 130% calculated by mechanical test at break and ideally in the range of about 120% to 125% calculated by mechanical test. Conceptually, the single blanket layer 12c could be considered to be relatively hard enough to be supportive of the exterior surface 12f being resistant to unwanted distortion of the image being transferred. While the single blanket layer 12c is composed of a relatively less compressible surface 12f, that surface 12f has pores 16 to compensate for the reduced compressibility, and therefore that surface 12f becomes capable of adequately carrying ink to the substrate 13.

Moreover, the single polyurethane blanket layer 12c of the bridged blanket sleeve 12 so produced is anticipated to be sufficiently consistent in regards to compressibility and surface tension so that the bridged blanket sleeve 12 will not need to be individually categorized (A, B or C) like conventional blanket sleeves. Because of the anticipated consistency of the compressibility and surface tension of the inventive bridged blanket sleeve 12, the operator of the offset printing press should not need to carry as many blanket sleeves in inventory. Because of the anticipated consistency of the compressibility and surface tension of the inventive bridged blanket sleeve 12, in the event of a failure of an inventive bridged blanket sleeve during operation of the offset printing press, the failed inventive bridged blanket sleeve should be able to be replaced more simply than if the operator was required to match the failed sleeve's rating of A, B, C. Accordingly, the operator of the offset printing press should be able to achieve more streamlined production when providing the offset printing press with the bridged blanket sleeve 12 of the present invention. Additionally, in packaging web offset presses such as those made by Drent Goebel of the Netherlands and Komori-Chambon of France and Charlotte, N.C., for which sleeves of variable circumferences are required, the present invention enables such sleeves to be manufactured more easily and thus at lower cost.

Other variants of embodiments of the invention can be defined in the light of the present text. For example, instead of forming the inventive single polyurethane blanket layer 12c on the outermost surface 30e of a precursor sleeve 29 to form an inventive bridged blanket sleeve 12, this single polyurethane layer 12c may just as easily be formed on the outer surface 30e of an intermediate bridge section 30 that has been integrally formed on a mandrel 11 and thus yield an inventive bridged blanket mandrel 10a as shown schematically in FIGS. 3 and 5. As shown schematically in FIG. 5, such an inventive bridged blanket mandrel 10a with the inventive single blanket layer 12c can be provided as part of an improved offset machine 14 for transferring data from the imaged surface 18 of a printing cylinder 19 to a substrate 13. Examples of machines 14 for which the inventive sleeves 12 and into which the inventive bridged blanket mandrels 10a are suitably incorporated, are disclosed in U.S. Pat. Nos. 5,440,981 and 5,429,048, which patents are hereby incorporated herein in their entirety for all purposes by this reference.

An inventive bridged blanket sleeve 12 and/or bridged blanket mandrel 10a with an inventive single blanket layer 12c of polyurethane material has/have been described together with methods for making same and the incorporation of such cylinder 10 and/or mandrel 10a as part of an improved offset printing machine. Although various embodiments of the invention have been described using specific terms, devices, and methods, such description is for illustrative purposes only. The words used are words of description rather than of limitation. It is to be understood that changes and variations may be made by those of ordinary skill in the art without departing from the spirit or scope of the present invention. In addition, it should be understood that aspects of the various embodiments may be interchanged both in whole or in part. Therefore, the spirit and scope of the appended claims should not be limited to the description of the presently preferred versions contained therein.

1. A blanket sleeve, to be drawn over a rotary support in order to define a blanket cylinder of an indirect or offset printing machine, this blanket cyllnder to cooperate with a lithographic plate cylinder from which the blanket cylinder receives the inked data to be printed and with a substrate onto which said inked data are to be transferred as said substrate moving between the blanket cylinder and a pressure cylinder, the blanket sleeve consisting essentially of:
an inner cylindrical portion configured to be drawn over the rotary support and defining an outer surface;
at least one intermediate bridge section having an inner surface contacting said outer surface of said inner cylindrical portion and having a cylindrically shaped exterior surface, at least a first portion of said intermediate bridge section being formed of polyurethane having a Shore D hardness of about 80; and
a single blanket layer formed on said cylindrically shaped exterior surface of said intermediate bridge section, said single blanket layer being formed at least partly of polyurethane material and defining an exterior surface configured to cooperate with the lithographic plate and with the substrate to be printed wherein tiny cells constituting no less than about 0.6 percent by weight and no more than about 4.4 percent by weight are uniformly dispersed throughout the single blanket layer.

2. A sleeve as in claim 1, wherein the intermediate bridge section includes at least a second portion, and the second portion of the intermediate bridge section is formed of polyurethane having a hardness of about 30 Shore D.

3. A sleeve as in claim 2, wherein the first portion of the intermediate bridge section is disposed between the blanket layer and the second portion of the intermediate bridge section.

4. A sleeve as in claim 3, wherein the intermediate bridge section includes at least a third portion of the intermediate bridge section, the third portion of the intermediate bridge section is formed of a composite material containing at least one kind of fibers selected from the group of kinds of fibers consisting of carbon fibers, glass fibers, and aramid fibers, and the second portion of the intermediate bridge section is disposed between the first portion of the intermediate bridge section and the third portion the intermediate bridge section.

5. A sleeve as in claim 4, wherein the intermediate bridge section includes at least a fourth portion formed of polyurethane having a hardness of about 40 Shore A, and the fourth portion of the intermediate bridge section is disposed between the third portion of the intermediate bridge section and the inner cylindrical portion.

6. A sleeve as in claim 5, wherein the third portion of the intermediate bridge section is formed of a composite material having a hardness of about 90 Shore D and containing at least one kind of fibers selected from the group of kinds of fibers consisting of carbon fibers, or glass fibers, or aramid fibers.

7. A blanket sleeve, to be drawn over a rotary support in order to define a blanket cylinder of an indirect or offset printing machine, this blanket cylinder to cooperate with a lithographic plate cylinder from which the blanket cylinder receives the inked data to be printed and with a substrate onto which said inked data are to be transferred as said substrate moving between the blanket cylinder and a pressure cylinder, the blanket sleeve consisting essentially of:
an inner cylindrical portion configured to be drawn over the rotary support and defining an outer surface;
at least one intermediate bridge section having an inner surface contacting said outer surface of said inner cylindrical portion and having a cylindrically shaped exterior surface, at least a first portion of said intermediate bridge section being formed of a metal layer; and
a single blanket layer formed on said cylindrically shaped exterior surface of said intermediate bridge section, said single blanket layer being formed at least partly of polyurethane material and defining an exterior surface configured to cooperate with the lithographic plate and with the substrate to be printed wherein tiny cells constituting no less than about 0.6 percent by weight and no more than about 4.4 percent by weight are uniformly dispersed throughout the single blanket layer.

8. A sleeve as in claim 7, wherein the intermediate bridge section includes at least a second portion, and the second portion of the intermediate bridge section is formed of polyurethane having a hardness of about 30 Shore D.

9. A sleeve as in claim 8, wherein the intermediate bridge section includes at least a third portion of the intermediate bridge section, and the third portion is disposed between the metal layer and the second portion of the intermediate bridge section, and the third portion of the intermediate bridge section is formed of a composite material containing at least one kind of fibers selected from the group of kinds of fibers consisting of carbon fibers, glass fibers, and aramid fibers.

10. A sleeve as in claim 9, wherein the intermediate bridge section includes at least a fourth portion formed of a composite material containing at least one kind of fibers selected from the group of kinds of fibers consisting of carbon fibers, glass fibers, and aramid fibers, and the second portion of the intermediate bridge section is disposed between the third portion of the intermediate bridge section and the fourth portion of the intermediate bridge section.

11. A sleeve as in claim 10, wherein the intermediate bridge section includes at least a fifth portion formed of polyurethane having a hardness of about 40 Shore A, and the fifth portion of the intermediate bridge section is disposed between the fourth portion of the intermediate bridge section and the inner cylindrical portion.

12. A sleeve as in claim 11, wherein the metal layer is disposed between the blanket layer and the third portion of the intermediate bridge section.

13. A sleeve as in claim 1, wherein at least a second portion of said intermediate bridge section being formed of polyurethane having a hardness of about 40 Shore A.

14. A sleeve as in claim 1, wherein tiny cells constituting no less than about one percent by weight and no more than about two percent by weight are uniformly dispersed throughout the single blanket layer.

15. A sleeve as in claim 1, wherein said single blanket layer contains cells constituting about 1.2 percent by weight of said single blanket layer.

16. A sleeve as in claim 1, wherein said intermediate bridge section has a radial thickness greater than said inner cylindrical portion and a radial thickness greater than said single blanket layer.

17. A sleeve as in claim 1, wherein said intermediate bridge section has a radial thickness greater than the combined radial thicknesses of said inner cylindrical portion and said single blanket layer.

18. A sleeve as in claim 1, wherein said single blanket layer contains spherical bodies defining said cells and containing a gas.

19. A sleeve as in claim 18, wherein said spherical bodies are microspheres comprising an outer skin surrounding a space containing gaseous isobutane and said skin being composed of material including a thermoplastic resin.

20. A sleeve as in claim 19, wherein said thermoplastic resin includes a copolymer containing monomer units selected from the group consisting of vinylidene chloride, or methacrylate or acrylonitrile.

21. A sleeve as in claim 18, wherein said spherical bodies are microspheres comprising a skin composed of material including a thermosetting resin of phenolic type.

22. A sleeve as in claim 1, wherein said single blanket layer includes polyurethane material containing swelling agents.

23. A sleeve as in claim 22, wherein said swelling agents are of the type that release gas when heated.

24. A sleeve as in claim 1, wherein said single blanket layer includes polyurethane material containing particles of water-soluble salts.

25. A sleeve as in claim 1, wherein said inner cylindrical portion is formed of one of metal and composite material; and
wherein said single blanket layer has a hardness of between about 50° Shore A and about 75° Shore A, an average metric surface roughness in a range of about 1.0 Ra micrometers and about 7.0 Ra micrometers, a density of between about 0.6 kg/dm³ and 0.8 kg/dm³ and an ultimate elongation of between about 110% and about 130%.

26. A sleeve as in claim 1, wherein said inner cylindrical portion is formed of nickel; and
wherein said single blanket layer has a hardness of about 60° Shore A, an average metric surface roughness of between about 3.0 Ra micrometers and about 5.0 Ra micrometers, a density of about 0.7 kg/dm³ and an ultimate elongation of about 120%.

27. A sleeve as in claim 1, wherein said polyurethane material is a polyether polyurethane.

28. A sleeve as in claim 1, wherein said polyurethane material is a polyester polyurethane.

29. A sleeve as in claim 1, wherein said single blanket layer is formed of open cell polyurethane material.

30. A sleeve as in claim 1, wherein said single blanket layer is formed of closed cell polyurethane material.

31. A sleeve as in claim 1, wherein said polyurethane material is elastomeric.

32. A sleeve as in claim 1, wherein said exterior surface of said single blanket layer has an average metric surface roughness in a range of between about 3.0 Ra micrometers and about 5.0 Ra micrometers.

33. A sleeve as in claim 1, wherein said exterior surface of said single blanket layer has an average metric surface roughness of about 4 Ra micrometers.

34. A sleeve as in claim 1, wherein said single blanket layer has a radial thickness in a range of about one millimeter to about two millimeters.

35. A sleeve as in claim 1, wherein said single blanket layer has a density of between about 0.6 kg/dm³ and 0.8 kg/dm³.

36. A sleeve as in claim 35, wherein said single blanket layer has a density of about 0.7 kg/dm³.

37. A sleeve as in claim 1, wherein said single blanket layer has a hardness of between about 50° Shore A and about 75° Shore A.

38. A sleeve as in claim 37, wherein said single blanket layer has a hardness of about 60° Shore A.

39. A sleeve as in claim 1, wherein said single blanket layer has an ultimate elongation of between about 110% and about 130%.

40. A sleeve as in claim 1, wherein said inner cylindrical portion is configured to be removably coupled to the rotary support.

41. A sleeve as in claim 1, wherein said inner cylindrical portion is configured to be integral with the rotary support

42. A sleeve as in claim 1, wherein said inner cylindrical portion is formed of metal.

43. A sleeve as in claim 42, wherein said inner cylindrical portion is obtained from metal wire.

44. A sleeve as in claim 1, wherein said inner cylindrical portion is formed of composite material.

45. A sleeve as in claim 44, wherein said inner cylindrical portion is formed of a composite material containing at least one kind of fibers selected from the group of kinds of fibers consisting of carbon fibers, or glass fibers, or aramid fibers.
